(19) United States
(12) Patent Application Publication
(10) Pub. No.: US 2021/0270062 A1
(43) Pub. Date: Sep. 2, 2021

(54) Electronic Central Locking System for Truck Service Body

(71) Applicant: The Shyft Group Duramag LLC, Novi, MI (US)

(72) Inventor: William G. CLEAVES, JR., Liberty, ME (US)

(73) Assignee: The Shyft Group Duramag LLC, Novi, MI (US)

(21) Appl. No.: 16/806,009

(22) Filed: Mar. 2, 2020

(51) Int. Cl. E05B 77/46; E05B 83/08; E05B 85/22; E05B 15/16; B60R 25/01; B60R 25/24; B60R 5/04

(52) U.S. Cl. CPC E05B 77/46; E05B 83/08; E05B 85/22; E05B 15/16; E05Y 2900/531; B60R 25/24; B60R 5/04; E05Y 2900/518; B60R 25/01

(57) ABSTRACT

A locking system is installed inside a truck work body such as a service body. A linear actuator drives a sliding member longitudinally between locked and unlocked positions. The sliding member is supported by slide bearings. A spring may bias the sliding member toward the unlocked position. Locking catches are secured on the compartment doors of storage compartments of the truck work body. Locking members protruding from the sliding member engage the locking catches in the locked position, and disengage from the locking catches in the unlocked position. The actuator may be wirelessly activated by a transmitter key fob. The actuator is mounted by tamper-resistant fasteners that are accessible and removable from the exterior of the work body, to release the actuator and unlock the system in the event of an actuator failure. A single actuator locks all compartments on one side of the work body.

### FIELD OF THE INVENTION

The invention relates to a system that can be electronically actuated to centrally lock the externally accessible storage compartments of a truck work body such as a service body, utility body, canopy body or van body. The invention further relates to a truck work body incorporating such an electronic central locking system, and relates to a kit of parts for retrofitting such an electronic central locking system in a previously existing truck work body.

### BACKGROUND INFORMATION

Work trucks for tradesmen, utility workers, service technicians, contractors and the like are often outfitted with a specialized work body mounted on the bare chassis of the truck. The term “work body” is intended to cover variants such as typically known service bodies, utility bodies, canopy bodies, van bodies etc., all having the common characteristic of externally accessible storage compartments with individually openable doors. The storage compartments provide for convenient transport, storage, organization and access of tools, equipment, and an inventory of parts and materials needed for the day-to-day work of the user of the truck. Because such a work truck thus becomes the “rolling shop” of the user, the storage compartments often contain thousands of dollars worth of hand tools, power tools, other equipment and parts inventories. It is thus of paramount importance to be able to securely lock all of the storage compartments, not only during a work day at a job site, but also when the truck is parked on non-work days.

To provide at least a minimum level of security, truck work bodies (service bodies, utility bodies, etc.) are typically sold with a paddle handle latch on each storage compartment door, and a key lock cylinder on each paddle handle latch. Thereby, each storage compartment can be individually locked and unlocked with a key. If the lock cylinder of a given paddle handle latch is left unlocked (for example during a work day at a job site), then that associated storage compartment door can be easily latched in the closed position or unlatched and opened by pulling the paddle handle. But if locked security is to be maintained, then each compartment door's lock cylinder must be individually manually unlocked and then relocked with the key each time that the individual storage compartment is to be accessed. This can become somewhat inconvenient during a work day when the storage compartments need to be accessed several times for various tools, equipment, parts etc. It is also recognized that the native or original-equipment key lock cylinders on the paddle handle latches provide only a very low level of security, more like a privacy lock or a theft hindrance rather than a theft prevention lock. Particularly, it is known that the key lock cylinders can be easily broken or entirely removed simply by engaging a screwdriver, dent puller or other suitable tool in the keyway and then twisting and pulling out the lock cylinder. For these reasons, additional locking systems have been developed.

The most basic and common centralized locking system for the external storage compartments of such truck work bodies is known as the “master lock” system offered by several manufacturers. Such systems typically involve along rod that extends internally along the length of the work body and includes tabs or pins that can engage respective catches provided on the compartment doors. The locking rod is spring-loaded to be biased to slide from a locked position (in which the locking tabs or pins of the locking rod engage the door catches) to an unlocked position (in which the tabs or pins of the locking rod are disengaged from the door catches). The locking rod further protrudes out through an external wall of the work body, and the externally accessible free end of the locking rod is provided with a handle and a fitting or fixture to which a conventional padlock can be secured. To lock this master lock system, the user pushes the external handle so as to slide the locking rod from the unlocked position to the locked position, and then secures a padlock on the fitting or fixture to hold and secure the locking rod in the locked position. To unlock the system, the user unlocks the padlock with a key or combination, removes the padlock and then pulls the handle, or allows the pre-tensioned spring, to slide the locking rod from the locked position to the unlocked position. Thereby, several compartment doors can be locked at once and from a centralized lock location by the locking bar.

Advantageously, the master lock system thereby provides a second level of locking and security in addition to the native key locks provided in the paddle handle latches of the compartment doors. The master lock system also provides the convenience of centralized locking, so that an individual padlock is not needed for each individual compartment door. Unfortunately, the externally exposed end of the locking rod as well as its lock fixture, and the external padlock, are subject to rusting, corrosion, freezing during wet cold weather, as well as intrusion attacks. Namely, a typical conventional padlock can be easily and quickly cut off using bolt cutters available to any thief. Thus, such a system also provides only a relatively low level of security. The problems of rusting and freezing can also make this system inconvenient or frustrating to operate if the padlock or the locking bar becomes stuck. Alternatively, it is necessary to manufacture the locking bar of hardened stainless steel or the like, to avoid or minimize corrosion and the possibility of bolt cutter attack of the externally exposed portion of the rod. Furthermore, it is inconvenient that each time any individual compartment locked by the master lock system is to be accessed, then the padlock needs to be manually unlocked and removed, the locking bar operated to the unlocked position, and then afterward needs to be manually relocked with the padlock. In the meantime the padlock can be misplaced or lost. Thus, a need has existed for a more convenient centralized locking system.

Electronic central locking systems have also been developed for truck work bodies. Such systems include electric actuators that move lock bolts between locked and unlocked positions for the external storage compartment doors that are to be centrally locked and unlocked. The actuators are activated by an electronic receiver that receives wireless signals from a transmitter typically embodied as a key fob or the like. Thereby, the user can simply press a corresponding button on the key fob, in order to open a selected compartment door or doors. Thus, advantageously, such electronic centralized locking systems provide the convenience of unlocking one or more compartment door with a simple click of a button on a key fob, and thus avoid the inconvenience of manually locking and unlocking a cumbersome padlock. Such known electronic locking systems provide a respective individual actuator for each individual storage compartment door. Thus, for a typical service body that has six external storage compartments, the known electronic systems include six actuators allocated to the six doors. One type of such system includes a respective rotary actuator operatively connected to the lock cylinder of each paddle handle latch of each individual door. Such a system thus operates at the level of the original equipment door lock, by locking or unlocking the lock cylinder, and does not provide a second level of locking security. Thus, the security level of such systems is no better than that of the original equipment locks in the paddle handle latches, because the entire lock cylinder can be easily removed with a screwdriver or dent puller as mentioned above. Another type of such known electronic locking systems provides a second level of locking security in addition to the original equipment paddle handle locks, by mounting an individual actuator at each compartment door, so that the individual actuator moves a locking bolt into or out of locking engagement at each door striker. Nonetheless, all of the known electronic locking systems suffer the disadvantages of relatively high complexity, a great number of parts including several actuators, and as a result a relatively high cost. Furthermore, such known systems do not provide a failsafe mechanism, so that when an individual actuator fails or loses electrical power (e.g. due to a dead battery of the vehicle or an electrical fault in the extensive wiring for the several actuators), then it is necessary to break or cut open the compartment door that is locked by the non-operable actuator.

### SUMMARY OF THE INVENTION

In view of the above, it is an object of the present invention to provide an electronic central locking system for a truck work body that combines the convenience of centralized locking and unlocking activated by an electronic key fob transmitter, together with the increased security of an internal secondary bar or rod locking system. More particularly, the present invention aims to reduce the complexity, the number of actuators, the number of other parts, and the cost of previously known electronic central locking systems for truck work bodies. Also, the invention aims to achieve a second level of locking provided by the electronic central locking system in addition to the basic native locking provided by the original equipment paddle handle locks. The invention further aims to avoid disadvantages of the common master lock system, such as avoiding external protrusion of the locking rod or bar, and avoiding the need for a separate cumbersome manually-operated padlock. A further object of the invention is to provide a failsafe mechanism to allow unlocking of the system in the event of actuator or electric failure. Yet another object of the invention is to provide a kit of parts that can be retrofitted into existing truck work bodies. The invention further aims to avoid or overcome the disadvantages of the prior art, and to achieve additional advantages, as apparent from the present specification. The attainment of these objects is, however, not a required limitation of the claimed invention.

The above objects can be achieved by a locking system according to the invention for a truck work body that has externally accessible storage compartment doors. The “work body” refers to a service body with an open truck bed, a utility body with a closed truck bed or closed compartment on the truck bed, a canopy body, a van body, or a combo body, and does not refer to but rather excludes the passenger cab of a work truck. The work body in any event includes externally accessible storage compartments that are each respectively closed by an openable door. The work body is mounted on the basic truck chassis of the work truck. According to the invention, the locking system includes a plurality of locking catches, a sliding member such as a sliding bar or rod (also called the locking bar), a plurality of locking members (such as locking tabs, pins, or bolts), a powered actuator, an electronic transmitter such as a key fob, and an electronic receiver. A locking catch is mounted on the inside of each one of the compartment doors that is to be lockable by the locking system. The sliding member is slidably arranged inside the truck work body so as to be longitudinally slidable between a locked position and an unlocked position. The locking members such as locking tabs are rigidly connected (e.g. welded or bolted) to, and protrude from, the sliding member so that the locking members respectively engage with the locking catches on the compartment doors when the sliding member is in the locked position, and so that the locking members respectively disengage from the locking catches on the compartment doors when the sliding member is in the unlocked position. The term “engaged” means that the locking member interacts with the locking catch so as to block an opening motion of the respective associated compartment door. Thereby, in the locked position, the locking members engaged with the locking catches prevent opening of the compartment doors, while in the unlocked position, the disengagement of the locking members from the locking catches allows the compartment doors to be opened.

The key fob transmitter is manually operated by a user, e.g. by pressing an appropriate one of several buttons provided on the transmitter, to selectively emit a lock signal and an unlock signal, which is transmitted to the electronic receiver that is arranged in the truck work body (or elsewhere on the truck) and connected for control signal transmission to the actuator. In response to the lock signal or unlock signal, the receiver activates and controls the actuator to drive the longitudinal sliding motion of the sliding member to the locked position and to the unlocked position respectively. For this, the electronic receiver is control-connected to the powered actuator, i.e. it is connected to be able to activate and control the actuator, for example by electric control wires and/or power supply wires.

The inventive locking system provides the convenience of centralized locking of several compartment doors at once, based on simple locking or unlocking activation via a portable transmitter such as a key fob. Because a single actuator is operative to lock and unlock several compartment doors at once (and preferably all of the compartment doors on one side of the work body), therefore the inventive locking system has a significantly reduced complexity, number of actuators, number of other parts, and cost relative to conventionally known locking systems that use a respective individual actuator for each individual compartment door.

Furthermore, the inventive locking system provides a second level of locking in addition to any original or native locks provided on the paddle handle latches of the individual compartment doors. Thus, for increased security, the locking system is activated to double-lock all of the compartment doors, in addition to the individual locking of each door provided by the original equipment lock on the paddle handle latch. For a reduced level of security, but easier access, for example during a work day at a job site, the individual door locks can be left unlocked, and all of the doors on a given side of the truck work body in unison can be quickly and easily locked and unlocked via the inventive central locking system controlled by the key fob transmitter. Alternatively, the centralized locking system can be left unlocked, while each individual compartment door is locked and unlocked as needed using the original equipment key lock.

The inventive locking system further avoids the inconvenient use of a separate padlock, and also avoids the external protrusion and cumbersome manual sliding of a centralized locking bar. Thereby, the invention avoids the problems of rusting and freezing of such external components.

Preferably, the locking system according to the invention further incorporates a failsafe mechanism to allow unlocking and opening the compartment doors in the event of a failure of an actuator or the electrical power supply to the actuator. To achieve this, the actuator (e.g. either an actuator device itself directly, or via a mounting bracket) is mounted internally on an exterior wall of the truck work body using tamper-resistant fasteners that are accessible from the exterior of the truck work body. Such tamper-resistant fasteners are, for example, threaded bolts or screws having a specialized head configuration that is not easily engaged by a typical conventional slotted screwdriver, phillips screwdriver, hex socket or wrench, solid internal driver bit, or locking pliers. A matching tool or driver bit for engaging the tamper-resistant fasteners is provided along with the locking system so that the owner/user of the work truck can relatively easily remove the tamper-resistant fasteners in the event of an actuator failure. Removing the tamper-resistant fasteners from the outside of the work body releases the actuator from its fixed mounting inside the work body, and then the special tool can be inserted from outside through a hole of one of the fasteners to push the actuator (and therewith also the sliding member) from the locked position to the unlocked position. Furthermore, an optional biasing spring may be connected between the sliding member or locking rod and a fixed point inside the truck work body, so as to apply a spring bias that urges the sliding member to slide toward the unlocked position. Thus, once the tamper-resistant fasteners are removed from the outside of the work body, then the spring tension of the biasing spring will “automatically” pull the sliding member together with the released actuator from the locked position to the unlocked position.

While this failsafe mechanism does reduce the level of security of the locking system, it should be understood that such a locking system is not intended as a guarantee of high security prevention of break-in attempts and thefts from the storage compartments, but rather merely as a deterrent and hindrance of such break-ins and thefts. Moreover, the tamper-resistant fasteners are preferably of a type that can only be unfastened using the matching special tool, and such a special tool is not readily available among the common tools carried by a would-be thief. In fact, certain types of tamper-resistant fasteners are available in hundreds of individual head patterns (almost like a key lock), so that it could even be provided that only the specific tool provided along with the specific locking system is able to unfasten the specific tamper-resistant fasteners of that locking system. Still further, the inventive locking system provides a second level of locking in addition to the original locks provided on the paddle handle latches of the compartment doors. Thus, even when the faulty actuator is released by removing the tamper-resistant fasteners, the compartment doors will still remain locked at their original level of security provided by the original key locks incorporated in the paddle handle latches. The special tool for removing the tamper-resistant fasteners would be kept, for example, in the glove compartment or door bin of the passenger cab of the work truck and could thus only be accessed by a person who has access to the interior of the passenger cab.

With the inventive locking system, preferably a total of two actuators can open all of the storage compartment doors on both sides of the truck work body. Namely, a single actuator can actuate all of the compartment doors on the respective associated side of the truck work body. In a further preferred embodiment, a rear door or rear doors of the truck work body can be locked and unlocked via a third actuator. For a configuration of a truck work body having side compartment doors at different heights, the locking members protruding from the sliding member are each respectively simply long enough to reach the associated one of the doors, whether it is in an upper row of doors or a lower row of doors, from the single sliding member comprising a single horizontal sliding bar. Alternatively, the sliding member may include two parallel sliding bars that are vertically offset from one another but interconnected so that they slide together in parallel with one another. In such an arrangement, an upper one of the sliding bars locks and unlocks the upper door(s) while a lower one of the sliding bars locks and unlocks the lower door(s).

### BRIEF DESCRIPTION OF THE DRAWINGS

In order that the invention may be clearly understood, it will now be described in connection with example embodiments thereof, with reference to the accompanying drawings, wherein:

FIG. 1 is an exterior perspective overview of a work truck with a service body that can be outfitted with an electronic central locking system according to the invention;

FIG. 2 is a schematic diagram of an example embodiment of a locking system according to the invention installed in the service body shown in FIG. 1, as seen looking outwardly from inside the service body on a longitudinal section plane of the storage compartments of the service body;

FIG. 3 is a diagram of significant components included in a kit for installing an example embodiment of a locking system in a truck work body;

FIG. 4 is a photographic view of an actuator installed in the service body, as seen in the extended or unlocking position of the actuator;

FIG. 5 is a photographic view of a locking bar with locking tab disengaged from the locking catch on the compartment door, in the unlocked position of the actuator and locking bar;

FIG. 6 is a photographic view similar to that of FIG. 4, but showing the actuator in the retracted or locked position;

FIG. 7 is a photographic view similar to that of FIG. 5, but showing the locking bar in the locked position, whereby the locking tab on the locking bar engages with the locking catch on the compartment door;

FIG. 8 is a photographic view of the mounting bracket of the actuator after it has been released by removing its tamper-resistant mounting bolts;

FIG. 9A is a schematic diagram showing a side view of another embodiment of a locking system according to the invention, as seen looking outwardly from inside a different configuration of service body on a longitudinal section plane A-A as shown in FIG. 9D;

FIG. 9B is an enlarged detail view of the detail area B shown in FIG. 9A;

FIG. 9C is an enlarged detail view of the detail area C shown in FIG. 9A;

FIG. 9D is a schematic diagram showing a rear view of the service body shown in FIG. 9A, and indicating the section plane A-A for FIG. 9A; and

FIG. 10 is a schematic diagram showing major components of an example embodiment of a locking system according to the invention, separate from (or omitting) the truck work body in which the locking system can be installed.

### DETAILED DESCRIPTION OF EXAMPLE EMBODIMENTS OF THE INVENTION

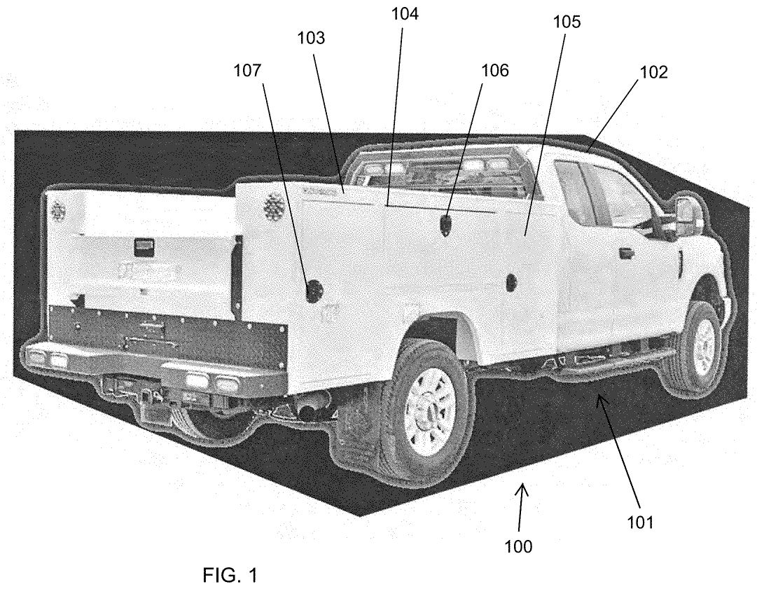

FIG. 1 shows a work truck 100 that includes a passenger cab 102 on a truck chassis 101. Furthermore, the work truck 100 has been outfitted with a service body 103 as an example of a work body 103 mounted on the truck chassis 101. The service body or work body 103 includes several externally accessible storage compartments 104 on each side of the truck 100. Each storage compartment 104 is selectively closed and opened by a compartment door 105. Each compartment door 105 is typically provided with a paddle handle latch 106 that includes a key lock cylinder 107, by which the door can be latched in the closed position, unlatched and pulled open, as well as key-locked in the closed latched position as desired. The storage compartments 104 provide convenient storage, organization and transport of tools, equipment, parts and materials used by tradesman, utility workers, service personnel etc. on location at job sites. Therefore, a user of the truck 100 will unlock, open, access, close and relock one or more of the storage compartments 104 many times throughout a typical workday. While the original key lock cylinders 107 may provide sufficient security for short-term daytime locking of the compartment doors 105 at a job site, an additional level of security is desired for overnight and long term locking of the compartments, and even daytime locking at some job sites where the risk of theft seems higher. Also, a locking system that is more convenient than the individual key lock cylinders 107 is desired. For these reasons, an electronic central locking system according to the invention can be installed in the service body 3 or other work body of a work truck, either as original equipment or as an aftermarket retrofit in an existing truck work body. The inventive locking system is preferably not externally exposed, and preferably essentially not visible from the exterior of the truck work body 103, for example except for the externally accessible tamper-resistant heads of a few tamper-resistant bolts as described further below.

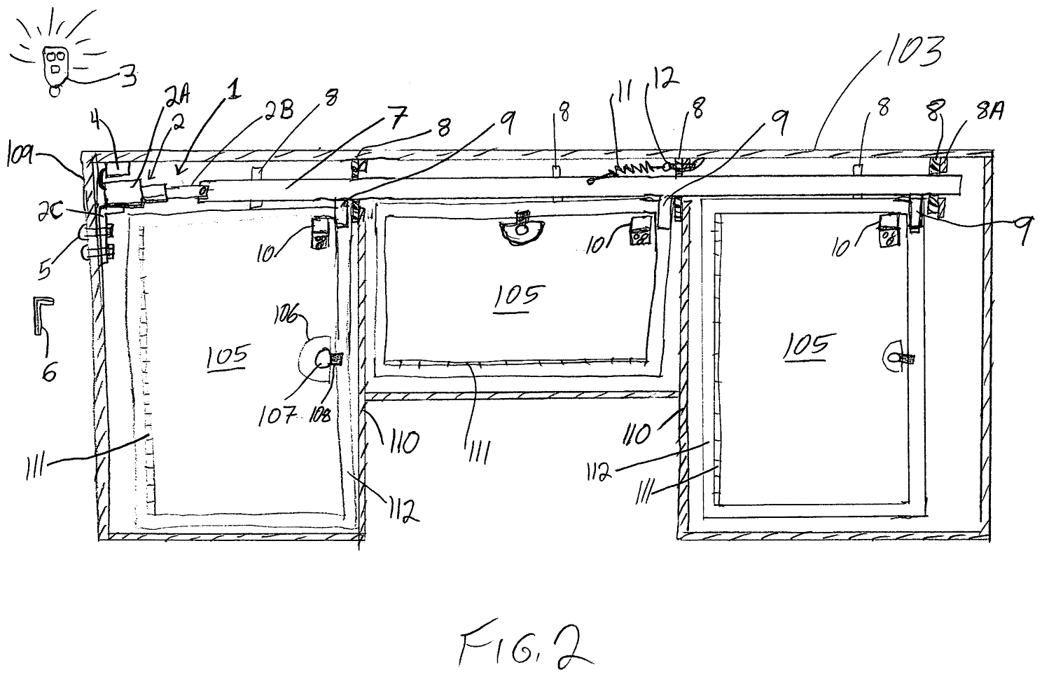

FIG. 2 is a schematic diagram of an example embodiment of the locking system according to the invention, as installed in the service body 103 shown in FIG. 1. The diagram of FIG. 2 is merely schematic, not to scale, and represents a view from inside the compartments 104 of the service body looking outwardly, whereby the left side of FIG. 2 is the forward end of the right side of the service body 103. This view looking outwardly from the inside of the work body 103 shows the inner side of each compartment door 105 that selectively closes each storage compartment 104. For this, each compartment door 105 is pivotably mounted by a hinge 111 such as a piano hinge to a door frame 112, so that the door 105 can pivot open and closed. The doors 105 are shown in their closed positions. The doors 105 are held in the closed positions by latch bolts 108 of the door latches 106. While the exterior paddle handle of the door latch 106 operates the latch bolt 108, the key lock cylinder 107 selectively locks or unlocks the latch bolt 108. This provides the basic native or original equipment locking security of each compartment door 105. The locking system 1 according to the invention provides an additional second level of locking security.

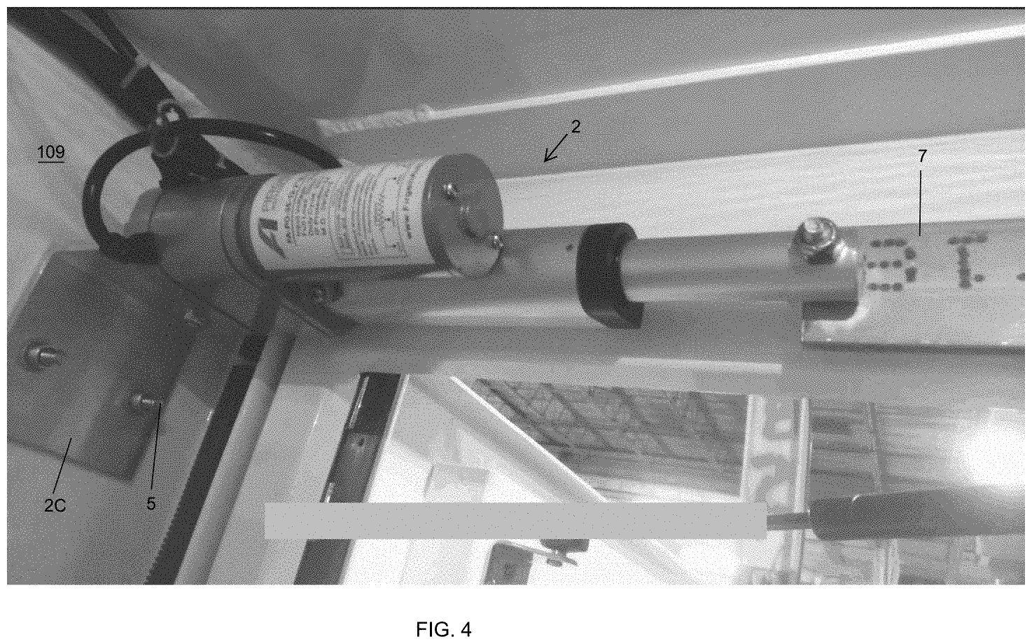

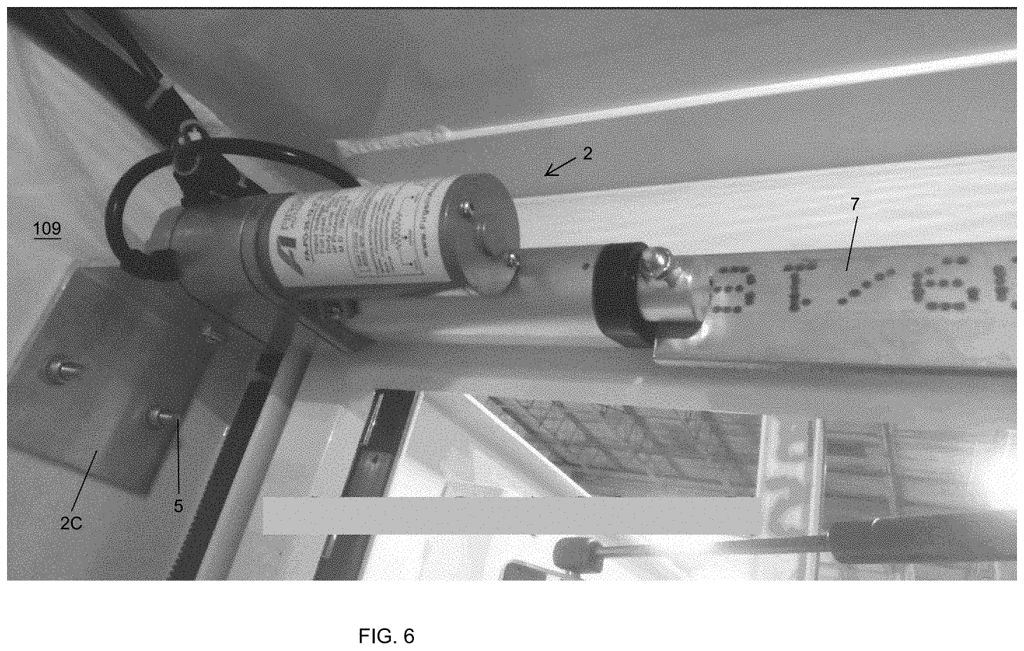

The locking system 1 includes a linear actuator 2 comprising an actuator body 2A and a drive rod 2B that is selectively linearly driven from the actuator body 2A outwardly to an extended position as shown in FIG. 2 (and see FIG. 4), or selectively driven linearly back inwardly into the actuator body 2A to a retracted position (see FIG. 6). A preferred example of a suitable actuator 2 is the classic rod linear actuator, model FA-240-S-12-2, from Firgelli Automations, which provides a 2-inch linear stroke with a 200-pound actuation force. This type of actuator uses an electric bi-directional rotary motor powered by 12 volts DC, coupled through a reduction gearing to an acme screw shaft, which in turn linearly extends and retracts the actuator drive rod 2B through a threaded coupling. Other types of linear actuators can alternatively be used, for example various types of electrically, hydraulically or pneumatically powered linear actuators, that may be selected based on convenience and the available power sources. An electrically driven linear actuator is the most common, because it can be conveniently powered from the typical 12 volt supply of the work truck.

The locking system 1 further includes a portable wireless electronic transmitter 3, for example embodied as a key fob with one or more pushbuttons. A preferred example of a suitable key fob transmitter is the model RC-5 remote key fob available from Firgelli Automations. When a user pushes a selected one of the buttons on the portable transmitter 3, it emits a corresponding wireless lock signal or unlock signal that is received by a cooperating receiver 4 arranged in the work body. The receiver 4 is control-connected to the actuator 2, i.e. connected for control signal transmission to the actuator 2, for example by control wires. A preferred example of a suitable receiver is the model 2Ch-Rem receiver available from Firgelli Automations. The actuator 2 is additionally connected by a wiring harness (not shown here) to a supply of electrical power, for example the onboard 12 volt DC supply of the work truck 100. When the receiver 4 receives a lock signal or unlock signal from the transmitter 3, it correspondingly actuates the actuator 2 to drive the drive rod 2B correspondingly to the retracted (e.g. locked) position or the extended (e.g. unlocked) position. In other embodiments, depending on the particular configuration of the compartments and the compartment doors, it may instead be desired to arrange the actuator so that the extended position of the drive rod 2B is the locked position, while the retracted position of the drive rod 2B is the locked position, but the illustrated preferred configuration is most suitable or convenient for the failsafe mechanism as will be described below.

The actuator body 2A and drive rod 2B together represent the actuator device, but the overall actuator arrangement may further include a mounting plate, base or bracket 2C by which the actuator 2 is mounted and secured on the interior side of the front exterior wall 109 of the truck work body 103. Particularly, the mounting bracket 2C is secured to the front exterior wall 109 by two tamper-resistant fasteners 5 such as bolts with tamper-resistant heads that are exposed and accessible from the exterior of the truck work body 103. These tamper-resistant bolts 5 are engaged into a threading in the bracket 2C or into suitable threaded sleeves, nuts or the like that are welded, crimped or otherwise secured to the bracket 2C. Thus, as will be described further below, if the tamper-resistant fasteners 5 are removed from the exterior of the truck work body 103, then the actuator 2 will be released from its mounted position. This will provide failsafe unlocking of the locking system 1 in the event of a failure of the actuator 2 or its electrical power supply, as will be described further below. The tamper-resistant fasteners have tamper-resistant heads that cannot be easily engaged by typical open end wrenches, box wrenches, hex sockets, locking pliers, phillips screwdrivers, slotted screwdrivers, allen wrenches, internal drivers, etc. Various configurations of such tamper-resistant fasteners are commercially available and can be selected depending on the desired level of security. A preferred example of a suitable tamper-resistant fastener is a bolt with a rounded head having an internal hex or other multi-sided female recess with a protruding center pin therein that prevents insertion of a standard solid-core allen wrench or the like. Instead, such a tamper-resistant fastener 5 can be engaged by a specialized removal tool 6, for example configured as a specialized allen-head wrench or other particular multi-sided configuration with a central recess that receives the central pin of the tamper-resistant head of the fastener. Such a matched fitting removal tool 6 is provided along with and as a component of the overall locking system 1.

The free end of the drive rod 2B of the actuator 2 is connected, e.g. by a bolt or clevis pin, to a sliding member 7, which in this example is embodied as a sliding rod 7 made of flat bar stock of aluminum or aluminum alloy having a rectangular cross-section configuration. Alternatively, other metals and other configurations such as a round-section rod may be used, but aluminum (including alloys thereof) is preferred due to its light weight, rust and corrosion resistance, and good strength-to-weight ratio. The flat bar configuration is preferred (e.g. over a round rod) due to its structural strength, torsional stability to resist twisting about its longitudinal axis when appropriately supported, and the convenience of assembling it with the further components described below. The sliding member or sliding bar 7 extends longitudinally inside the work body 103 in the fore-aft direction the work truck 100, and is supported so that it is slidable longitudinally in this fore-aft direction.

Particularly, the sliding member 7 is supported by several slide bearings 8, which preferably each comprise a block of low-friction plastic such as HDPE (high density polyethylene) or PTFE (polytetrafluoroethylene). Some of the slide bearings 8 include two blocks of such low friction plastic arranged on the opposite sides of the sliding bar 7, or a single block of low friction plastic with a passage channel machined through it to receive and slidably support the sliding bar 7 extending therethrough. Other slide bearings 8 are simply a block of the low friction plastic arranged only on one side of the sliding bar 7, for example on the outer side thereof. The slide bearings 8 prevent outward deflection of the sliding bar 7, and support the sliding bar 7 against torsion or tilting about its longitudinal axis, while allowing smooth sliding of the sliding bar 7 in the longitudinal direction. The individual slide bearings 8 are secured and supported on the structure of the truck work body 103 in various different manners. For example, the flat block type of slide bearing 8 may simply be adhesively mounted onto the side wall structure of the truck work body 103 itself, and the two-part or passthrough channel type of slide bearing 8 may be mounted on an interior partition wall 110 of the truck work body 103 between adjacent ones of the storage compartments 104. In this case, a corresponding through-passage is cut through the partition wall 110 to allow the sliding member 7 to pass therethrough. As a further alternative, a suitable metal bracket 8A may be provided to support the slide bearing 8 and secure it to the structure of the truck work body 103. During the development and refinement of the locking system, it was discovered that binding and friction of the sliding member 7 was a significant problem to be overcome, because essentially any binding or frictional resistance to sliding of the sliding member 7 could cause the actuator 2 to lock-up or burn-out. The slide bearings 8 of low friction plastic such as HDPE, in combination with a flat aluminum bar stock as the sliding member 7 were found to be the best solution to the frictional binding problem.

To selectively lock and unlock preferably all of the compartment doors 105 on one side of the truck work body 103, the locking system 1 further includes a respective locking catch 10 secured (e.g. bolted, screwed, riveted or welded) to each compartment door 105, and a corresponding plurality of locking members 9, embodied as locking tabs 9 in this example, fixed to and protruding from the sliding bar 7 so as to operatively cooperate with the locking catches 10 as described in detail below. For example, the locking members or tabs 9 are also made from aluminum or aluminum alloy flat bar stock, and are fixed to the sliding member or bar 7 by welding or bolting. If a higher or stronger degree of locking security of the doors 105 is desired, then an additional second locking catch 10 and an additional second locking tab 9 can be provided for each door 105, but it has been found that generally a single locking catch 10 and cooperating locking tab 9 for each door is adequate.

FIG. 2 shows the locking system 1 in the unlocked position, with the drive rod 2B extended from the actuator body 2A, whereby the sliding member 7 e.g. sliding bar 7 has been slid toward the right to its unlocked position. In this unlocked position, the locking members or locking tabs 9 fixed to the sliding member 7 are longitudinally offset (in the longitudinal direction of the sliding bar 7) from and thus not engaged with the locking catches 10 provided on the compartment doors 105. Preferably, in the unlocked position, the locking members or locking tabs 9 are also offset out of the door opening, for example are parked at locations inwardly from the door frames 112. Thereby, the locking members or tabs 9 do not block free, clear, unobstructed access to the storage compartments when the doors 105 are opened.

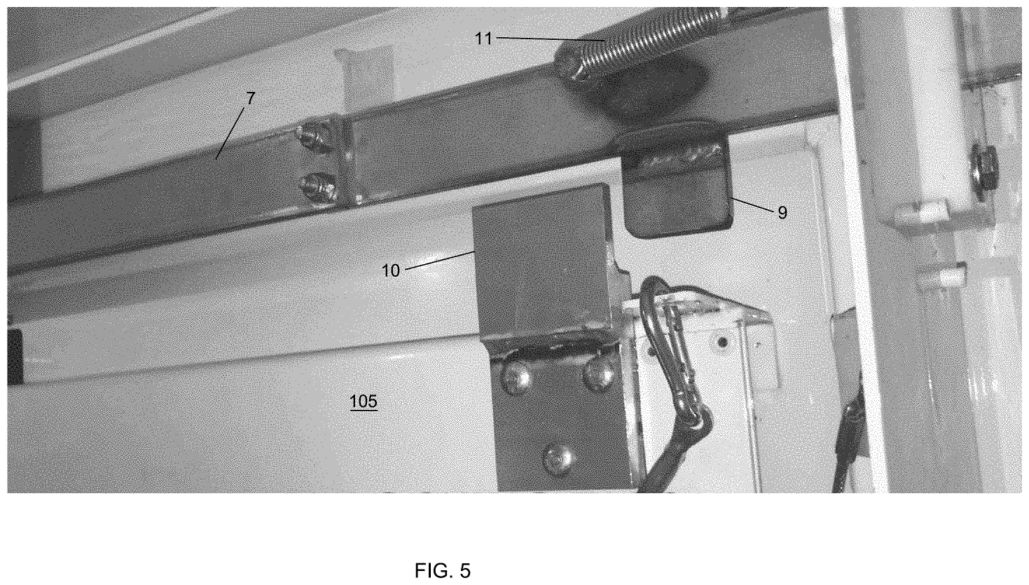

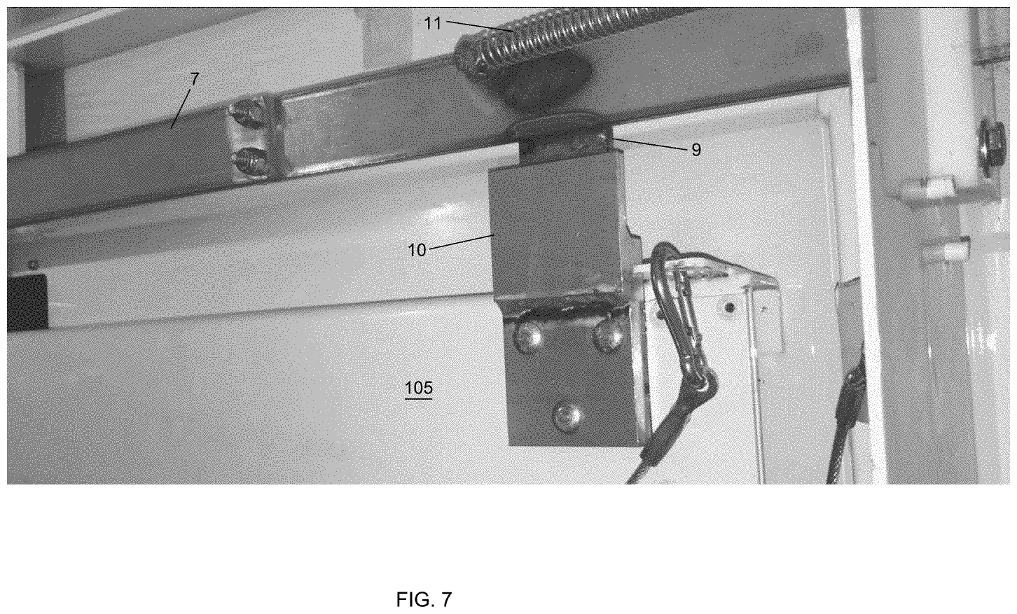

On the other hand, when the actuator 2 is activated to drive the drive rod 2B inwardly toward the left relative to the actuator body 2A, then the drive rod 2B and the attached sliding member or bar 7 slides toward the left into the locked position (not shown in FIG. 2, but see FIGS. 6 and 7). In the locked position, the sliding member or bar 7 with its locking members or tabs 9 has slid toward the left just far enough so that the locking tabs 9 slide into alignment with the locking catches 10 and engage behind, i.e. on the outwardly facing side of, the locking catches 10. Namely, the locking tabs 9 of the sliding bar 7 engage between the locking catches 10 and the inner surface of the compartment doors 105. This configuration can be understood further with reference to FIG. 7 showing the locked position in comparison to FIG. 5 showing the unlocked position.

Furthermore, the biasing spring, preferably a tension spring 11 is optionally connected between the sliding member 7 and a fixed point on the structure of the truck work body 103, e.g. to a mounting bracket or a compartment partition wall 110, preferably via an adjustment screw 12 that allows the level of tension of the spring 11 to be adjusted. The spring 11 applies a spring bias in the longitudinal sliding direction of the sliding member 7, to urge the sliding member 7 from its locked position toward its unlocked position. The spring tension of the spring 11 is less than the actuation force of the actuator 2, so that the actuator can drive the sliding member 7 from the unlocked position to the locked position against the spring tension force. Furthermore, the spring tension is less than the static or parked force of the actuator 2 when it is parked and unpowered in the locked position. Thus, the locking system 1 will remain in the locked condition even when the actuator 2 is deactivated and unpowered in its retracted locked position.

If the actuator 2, the transmitter 3, or the receiver 4 fails, or if the electrical power supply to the actuator 2 is interrupted, then the system 1 would remain fixed in the locked position, and it would not be possible to access the storage compartments 104. To provide a failsafe mechanism to enable unlocking of the system 1 in the event of such a failure, the actuator 2 is preferably mounted to the structure of the work body 3 by externally accessible tamper-resistant fasteners 5 as described above. Thus, in the event of such a failure, the authorized user of the truck simply uses the provided removal tool 6 to remove the fasteners 5 from the exterior of the truck work body 103. When the fasteners 5 are removed, the mounting bracket 2C of the actuator 2 is released and separates from the front exterior wall 109 of the truck work body 103. Then, as a result, the spring tension of the (optional) biasing spring 11 pulls the sliding member 7 along with the entire actuator 2 (toward the right in FIG. 2) from the locked position to the unlocked position. Alternatively, in the simplest preferred embodiment without the biasing spring, after the fasteners 5 have been removed, the authorized user inserts the removal tool 6 or some other suitable tool through one of the mounting holes of the fasteners and, using the tool, pushes the bracket 2C inwardly away from the front exterior wall 109 of the truck work body. Thereby, the actuator 2 and the connected sliding member 7 are pushed (toward the right in FIG. 2) from the locked position to the unlocked position. In both embodiments (with or without the biasing spring), thereby the locking tabs 9 also slide toward the right and disengage from the locking catches 10 so that the compartment doors 105 are released or unlocked, and may be opened in the usual manner without hindrance by the locking system. The basic level of security for the storage compartments 104 is maintained, because the original equipment door latches 106 with key lock cylinders 107 remain operational whereby the latch bolts 108 can keep the doors 105 locked closed until unlocked with the original key. Furthermore, it is not readily apparent from the exterior of the truck work body 103 that the tamper-resistant fasteners 5 will disable the secondary central locking system 1 and transition it to an unlocked condition. Even if that is known or suspected, the tamper-resistant fasteners 5 cannot be readily and easily engaged with standard typical tools, but instead require a special removal tool 6. The removal tool 6 provided along with the locking system 1 can be stored securely in the locked passenger cab 102 of the work truck 100 until it might become needed in the rare event of an actuator failure.

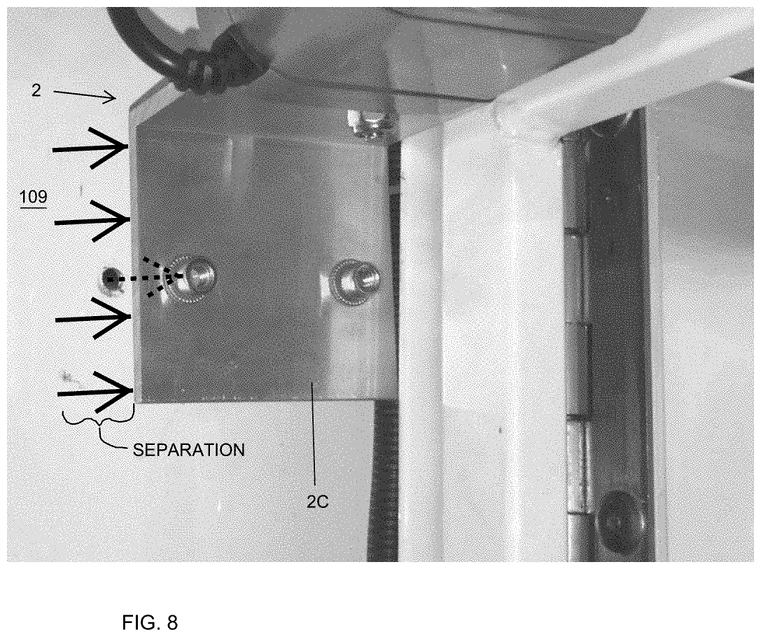

FIG. 4 shows the actuator 2, and FIG. 5 shows the locking member 9, locking catch 10 and biasing spring 11 in the unlocked position. FIG. 6 shows the actuator 2, and FIG. 7 shows the locking member 9, locking catch 10 and biasing spring 11 in the locked position. FIG. 8 shows the mounting bracket 2C of the actuator 2 after the tamper-resistant fasteners 5 have been removed, whereby the entire actuator 2 has been released and pulled away from the front exterior wall 109 of the truck work body 103 under the influence of the biasing spring 11, which moves the sliding member 7 and locking members 9 from the locked position into the unlocked position.

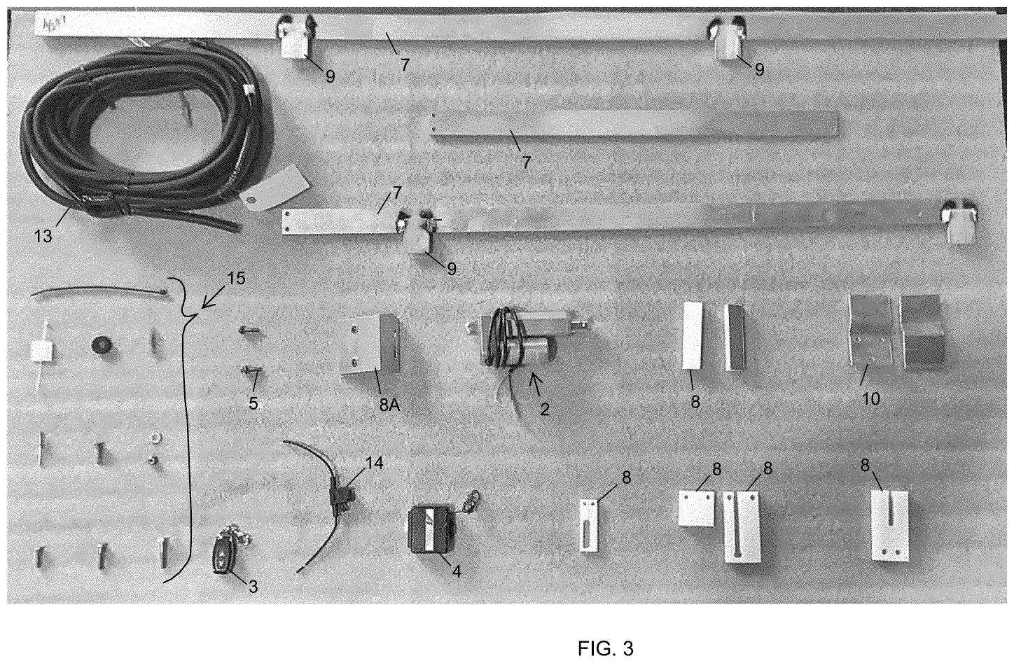

FIG. 3 gives an overview of the major components of an example of the inventive locking system 1, which can be considered as the components of a kit to be assembled and installed in a truck work body 103, for example as described above. While FIG. 3 shows all of the individual components, it does not show the total necessary piece count of each component for a complete installation. The component parts of the system or kit include many of the components described above, such as the actuator 2, transmitter or key fob 3, electronic wireless receiver 4, tamper-resistant fasteners 5, sliding members or particularly sliding bars 7 with attached locking members or tabs 9, various configurations of slide bearings 8, as well as locking catches 10 to be secured on the compartment doors. Additionally, the system or kit includes a wiring harness 13 for supplying electrical power to the actuator 2, and preferably also a fuse in a fuse holder 14 to provide over-current protection to the electrical circuit. Furthermore, various hardware parts 15 such as screws, bolts, washers, nuts, electrical connectors, rubber grommets, slide lock straps, etc. are used for assembling and installing the components in the truck work body.

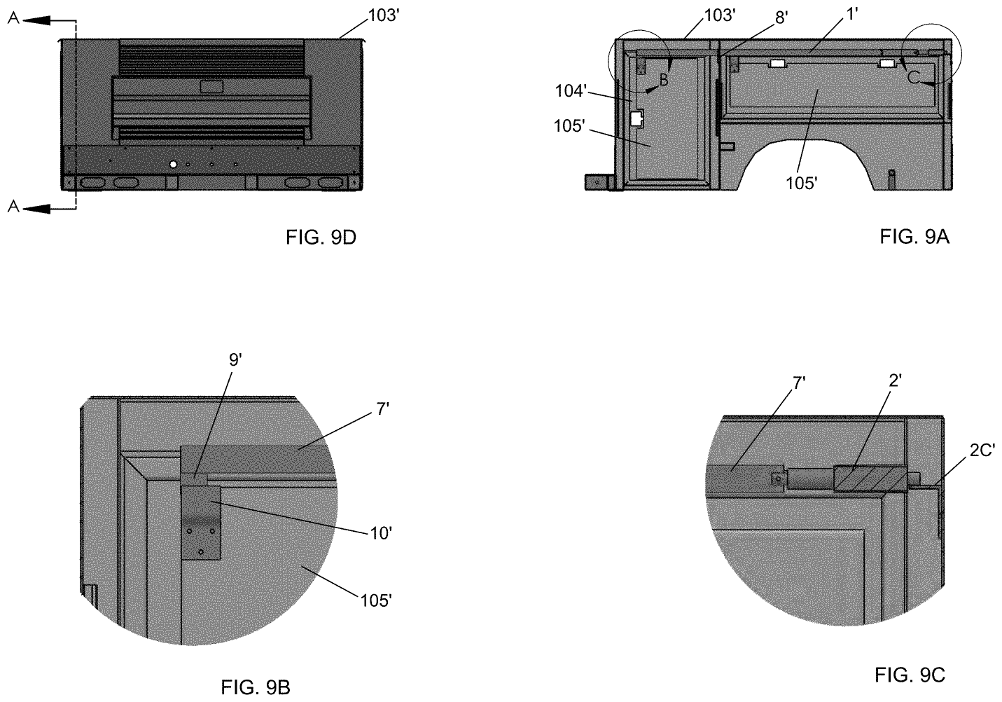

The several views of FIG. 9 show another example of a locking system 1′ according to the invention installed in a smaller service body 103′ for a shortbed truck. This service body 103′ has only two storage compartments 104′ with corresponding compartment doors 105′ on each side (left and right). FIG. 9D shows a rear view of the service body 103′, FIG. 9A shows the longitudinal section according to the section line A-A of FIG. 9D, thus looking outwardly from the inside of the storage compartments 104′ on the left side of the service body 103′. FIG. 9B is an enlarged view of the detail area B of FIG. 9A, and FIG. 9C is an enlarged view of the detail area C of FIG. 9A. The locking system 1′ installed in this service body 103′ is shorter in length and somewhat simpler than the locking system 1 described above in connection with FIG. 2, but is otherwise generally similar. Namely, this example of a locking system 1′ includes an actuator 2′ driving a sliding bar 7′, which is supported in one or more slide bearings 8′, and to which are attached two locking members or tabs 9′ for selective engagement with locking catches 10′ respectively secured on the two compartment doors 105′. The actuator device of the actuator 2′ is mounted by a mounting bracket 2C′ via tamper-resistant fasteners on a front wall of the service body 103′. Just like in the other embodiment described above in connection with FIG. 2, the actuator 2′ is remotely wirelessly activated by a transmitter such as a key fob transmitter via an electronic receiver of the system. The transmitter and receiver are not shown in FIG. 9. These views of FIG. 9 show the system in the locked position as described above.

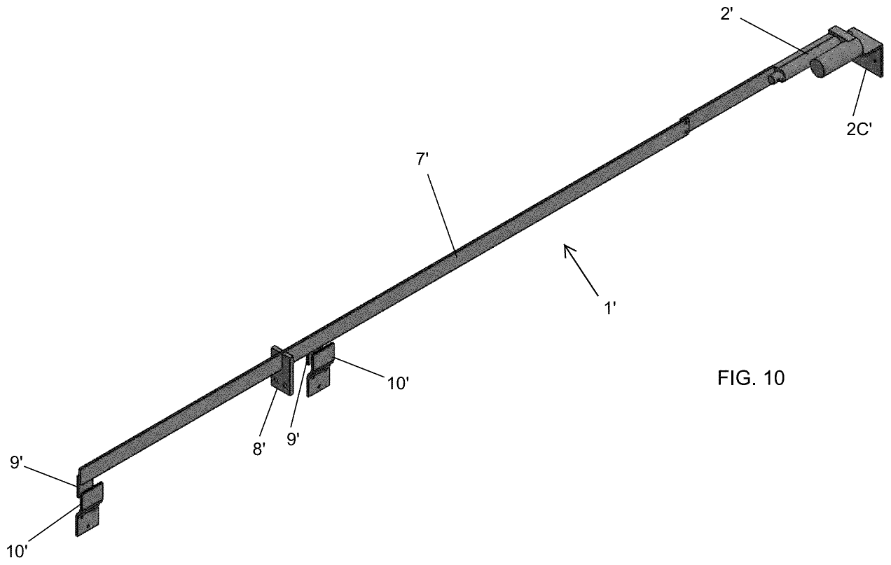

FIG. 10 is a perspective view of major components of the locking system 1′ of FIG. 9 in isolation (i.e. without the truck service body 103′). This perspective view can provide a further understanding of the arrangement and interaction of the actuator 2′, the sliding bar 7′, the slide bearing 8′, the two locking tabs 9′ and the two locking catches 10′.

Variants of the above described features are provided in further embodiments that are not illustrated. For example, the locking member may be a locking pin or bolt instead of a locking tab. In that case, the locking catch is not merely a flat plate extending essentially parallel to the plane of the door, but rather a plate that extends perpendicular to the door and to the sliding member, and that has a hole or recess into which the locking pin or bolt slides as the sliding member moves to the locked position from the unlocked position. In another embodiment, the actuator is mounted by its own base to the exterior wall of the truck work body, rather than via an additional mounting bracket. Alternatively, the actuator may be mounted on a mounting panel, that itself is fastened by the tamper-resistant fasteners so as to cover an opening in the exterior wall of the truck work body. When the tamper-resistant fasteners are removed, the entire panel and the actuator thereon is released and can be pushed or spring-driven inwardly to unlock the system. As an alternative to the key fob, the transmitter may be a numeric code numeric keypad that is mounted on the exterior of the truck work body and hardwired to the receiver.

In the illustrated embodiments, all of the doors have a free edge (any edge without the door hinge) at least approximately at the same height, and particularly aligned near the top of the service body. Thereby the door locking catches can all be arranged near the top of the service body, and can all be engaged by locking tabs of substantially similar length protruding downwardly from a single sliding bar running along the top interior of the service body (respectively on each side of the service body). However, other configurations of truck work bodies have doors with free edges at different heights. For such configurations, the sliding member on a respective side of the truck work body may include either:
(1) two sliding bars arranged at different heights but linked (e.g. by at least one connector bar that rigidly interconnects the two sliding bars with one another) so as to slide together in unison and parallel with one another to lock/unlock the doors at different heights; or
(2) a single sliding bar with respective locking tabs having different lengths and/or some locking tabs extending upwardly and some locking tabs extending downwardly from the single sliding bar, as necessary to reach the door locking catches at different heights;
so that the single sliding member (including one or two sliding bars) is operative to lock/unlock all of the doors (at different heights) on one side of the truck work body.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims. The abstract of the disclosure does not define or limit the claimed invention, but rather merely abstracts certain features disclosed in the application.

What is claimed is:

1. A locking system for a truck work body that has externally accessible compartment doors, wherein the locking system comprises:
a plurality of locking catches that are mounted respectively on a plurality of the compartment doors which are to be lockable by the locking system;
a sliding member that is longitudinally slidably arranged inside the truck work body so as to be longitudinally slidable between a locked position and an unlocked position;
a plurality of locking members that are rigidly connected to and protrude from the sliding member so that the locking members respectively engage with the locking catches to prevent opening of the plurality of the compartment doors when the sliding member is in the locked position, and so that the locking members respectively disengage from the locking catches to allow opening of the plurality of the compartment doors when the sliding member is in the unlocked position;
an actuator that is operatively connected to the sliding member and is configured to drive a longitudinal sliding motion of the sliding member between the locked position and the unlocked position;
an electronic transmitter that is configured to be manually operated by a user to selectively emit a lock signal and an unlock signal; and
an electronic receiver that is control-connected to the actuator, and is configured to receive the lock signal and the unlock signal and to respectively responsively control the actuator to drive the longitudinal sliding motion of the sliding member to the locked position and to the unlocked position respectively.

2. The locking system according to claim 1, further comprising tamper-resistant fasteners by which the actuator is secured inside the truck work body, wherein the tamper-resistant fasteners are accessible and removable from outside of the truck work body so as to release the actuator.

3. The locking system according to claim 2, further comprising a biasing spring that is connected between the sliding member and a point inside the truck work body, to apply to the sliding member a spring bias that urges the sliding member to slide from the locked position to the unlocked position.

4. The locking system according to claim 2, further comprising a removal tool that fits and engages a head configuration of the tamper-resistant fasteners, and that enables removal of the tamper-resistant fasteners.

5. The locking system according to claim 2, wherein the tamper-resistant fasteners are the only parts of the locking system that are exposed externally from the truck work body.

6. The locking system according to claim 1, wherein the sliding member is arranged entirely within the truck work body, and no part of the sliding member protrudes externally from the truck work body.

7. The locking system according to claim 1, further comprising slide bearings that are mounted in the truck work body and slidably support the sliding member.

8. The locking system according to claim 7, wherein the slide bearings comprise blocks of low-friction plastic selected from HDPE and PTFE.

9. The locking system according to claim 1, wherein the sliding member comprises a sliding bar of aluminum or aluminum alloy having a rectangular cross-sectional configuration, and the locking members comprise locking tabs of aluminum or aluminum alloy that are welded or bolted to the sliding bar.

10. The locking system according to claim 1,
wherein the truck work body includes respective ones of the plurality of compartment doors having respective free edges thereof at different heights,
wherein respective ones of the locking catches are arranged at different heights,
wherein the sliding member includes only a single sliding bar arranged at a single height in the truck work body on a respective side of the truck work body, and
wherein respective ones of the locking members have different lengths protruding from the sliding bar and/or respective ones of the locking members protrude from the sliding bar in different upward or downward directions so as to respectively reach and engage with the locking catches arranged at different heights.

11. The locking system according to claim 1, wherein the sliding member on a respective side of the truck work body includes two sliding bars that are vertically offset from one another and extend parallel to one another, and at least one connector bar that rigidly interconnects the two sliding bars with one another so that the two sliding bars are both longitudinally slidable in unison and parallel to one another.

12. The locking system according to claim 1, wherein the locking members and the locking catches are positioned so that the locking members do not protrude into respective door openings of the compartment doors when the sliding member is in the unlocked position.

13. The locking system according to claim 1, including a total of only two of the actuators for locking and unlocking all of the compartment doors on a right side and on a left side of the truck work body.

14. The locking system according to claim 1, wherein a single said actuator locks and unlocks all of the compartment doors on a right side or on a left side of the truck work body.

15. The locking system according to claim 1, expressly excluding an externally accessible key lock or combination lock for locking the sliding member.

16. A combination comprising the locking system according to claim 1 assembled and installed in the truck work body.

17. A kit of parts for assembling and installing a locking system in a truck work body that has externally accessible compartment doors, wherein the parts comprise:
locking catches configured to be mounted on an interior of a plurality of the compartment doors which are to be lockable by the locking system;
a sliding member configured to be longitudinally slidably arranged inside the truck work body so as to be longitudinally slidable between a locked position and an unlocked position;
locking members rigidly connected to and protruding from the sliding member, so that the locking members respectively engage with the locking catches to prevent opening of the plurality of the compartment doors when the sliding member is in the locked position, and so that the locking members respectively disengage from the locking catches to allow opening of the plurality of the compartment doors when the sliding member is in the unlocked position;
an actuator configured to be operatively connected to the sliding member, and to drive a longitudinal sliding motion of the sliding member between the locked position and the unlocked position;
an electronic transmitter configured to be manually operated by a user to selectively emit a lock signal and an unlock signal; and
an electronic receiver configured to be control-connected to the actuator, and to receive the lock signal and the unlock signal and to responsively control the actuator to drive the longitudinal sliding motion of the sliding member to the locked position and to the unlocked position respectively.

18. The kit according to claim 17, wherein the parts further comprise tamper-resistant fasteners configured to secure the actuator inside the truck work body, whereby the tamper-resistant fasteners are accessible and removable from outside of the truck work body so as to release the actuator.

19. The kit according to claim 18, further comprising a biasing spring configured to be connected between the sliding member and a point inside the truck work body, to apply to the sliding member a spring bias that urges the sliding member to slide from the locked position to the unlocked position.

20. The kit according to claim 17, wherein the parts further comprise slide bearings of a low-friction plastic configured to be mounted in the truck work body and slidably support the sliding member.
